(19) United States
(12) Patent Application Publication
(10) Pub. No.: US 2024/0267972 A1
(43) Pub. Date: Aug. 8, 2024

(54) Prediction and Proactive Handling of Radio Link Failures

(71) Applicant: Telefonaktiebolaget LM Ericsson (publ), Stockholm (SE)

(72) Inventors: Antonino Orsino, Kirkkonummi (FI); Stefan Wager, Espoo (FI); Per Willars, Vaxholm (SE)

(21) Appl. No.: 18/564,267

(22) PCT Filed: Jul. 1, 2022
(86) PCT No.: PCT/SE2022/050663

§ 371 Date: Nov. 27, 2023

Related U.S. Application Data
(60) Provisional application No. 63/228,683, filed on Aug. 3, 2021.

(51) Int. Cl. H04W 76/18; H04W 36/30

(52) U.S. Cl. CPC H04W 76/18; H04W 36/305

(57) ABSTRACT

Embodiments include methods for a user equipment (UE) configured to communicate with a wireless network via a primary cell (PCell) and one or more secondary cells (SCells). Such methods include receiving, from the wireless network, a plurality of configurations for a corresponding plurality of candidate PCells. Such methods include selecting one of the configurations upon occurrence of a failure event in a first cell configured as the PCell and switching the PCell from the first cell to the candidate PCell corresponding to the selected configuration. Other embodiments include complementary methods for a network node of the wireless network, as well as UEs and network nodes configured to perform such methods.

### TECHNICAL FIELD

The present disclosure relates generally to wireless networks, and more specifically to improvements in handling of radio link failures (RLFs) experienced by user equipment (UEs) in wireless networks, particularly when such UEs have a single connection to a wireless network.

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within 3GPP. NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Dual connectivity (DC) was introduced in LTE Rel-12. In DC operation, a UE consumes radio resources provided by at least two different network points connected to one another with a non-ideal backhaul. In general, these two are referred to as master node (MN) and secondary node (SN). DC can be viewed as a special case of carrier aggregation (CA), in which the aggregated carriers (or cells) are provided by network nodes that are physically separated and not connected via a robust, high-capacity connection.

DC is also envisioned as an important feature for 5G/NR networks. Several DC (or more generally, multi-connectivity) scenarios have been considered for NR. These include NR-DC in which both MN and SN (e.g., gNBs) employ the NR interface to communicate with the UE. In addition, various multi-RAT DC (MR-DC) scenarios are specified, whereby a UE can be configured to uses resources provided by two different nodes, one providing E-UTRA/LTE access and the other one providing NR access. One node acts as the MN (e.g., providing MCG) and the other as the SN (e.g., providing SCG), with the MN and SN being connected via a network interface and at least the MN being connected to a core network (e.g., EPC or 5GC).

Each of the CGs includes one MAC entity, a primary cell (PCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG, respectively. In non-DC operation (e.g., CA), SpCell refers to the PCell. An SpCell is always activated and supports physical UL control channel (PUCCH) transmission and contention-based random access by UEs.

The network (e.g., serving gNB) can configure a UE to perform and report radio resource management (RRM) measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures.

### SUMMARY

A radio link failure (RLF) procedure is typically triggered in the UE when something unexpected happens in any of these mobility-related procedures. The RLF procedure involves interactions between radio resource control (RRC) protocol and lower layer protocols such as physical layer (PHY, or Li), medium access control (MAC), radio link control (RLC), etc. For example, RLF is based on radio link monitoring (RLM) on Li. One consequence of RLF is that the UE needs to re-establish its connection via signaling with a newly selected cell (e.g., random access procedure, exchanging various RRC messages, etc.), which introduces latency until the UE can again reliably transmit and/or receive user data with the network.

However, there are various problems, issues, and/or difficulties with RLF for NR UEs operating in non-DC modes such as CA, particularly at high frequencies where the likelihood of experiencing RLF due to propagation loss and blockages greatly increases.

Embodiments of the present disclosure provide specific improvements to predicting and handling RLF by UEs operating in CA in a wireless network, such as by facilitating solutions to overcome the exemplary problems summarized above and described in more detail below.

Some embodiments of the present disclosure include methods (e.g., procedures) for a UE configured to communicate with a wireless network via a PCell and one or more SCells.

These exemplary methods can include receiving, from the wireless network, a plurality of configurations for a corresponding plurality of candidate PCells. These exemplary methods can also include selecting one of the configurations upon occurrence of a failure event in a first cell configured as the PCell. These exemplary methods can also include switching the PCell from the first cell to the candidate PCell corresponding to the selected configuration.

In some embodiments, switching the PCell from the first cell to the candidate PCell of the selected configuration is performed without an RRC reconfiguration procedure.

In some embodiments, the plurality of configurations are included in a respective plurality of RRCReconfiguration messages or SpCellConfig IEs. Furthermore, the plurality of RRCReconfiguration messages or SpCellConfig IEs are received in one or more RRCReconfiguration messages.

In various embodiments, each of the plurality of configurations has one or more of the following characteristics:
corresponds to a candidate PCell that is different than the first cell;
includes one or more candidate SCells that are different than currently active SCells;
facilitates sending an indication about a PCell failure event to the wireless network;
facilitates switching PCell without performing an RRC reconfiguration procedure; and
facilitates switching at least one currently active SCell without performing an RRC reconfiguration procedure.

In some embodiments, the one or more SCells include a second SCell that is configured as an active SCell before the failure event. In such embodiments, these exemplary methods can also include, based on switching the PCell to the candidate PCell, switching the active SCell from the second cell to a candidate SCell associated with the candidate PCell.

In some embodiments, the failure event can be one of the following: detected RLF in the first cell; detected radio problems indicating early RLF in the first cell; expiration of a timer indicating early RLF in the first cell; or predicted RLF in the first cell.

In some embodiments, these exemplary methods can also include receiving an indication of the failure event from the wireless network. In other embodiments, these exemplary methods can also include detecting or predicting occurrence of the failure event.

In some of these embodiments, detecting or predicting occurrence of the failure event can include predicting RLF in the first cell based on a machine learning (ML) model and on one or more of the following: in-sync and out-of-sync indications from the UE's physical layer; and measurements made by the UE in the first cell. In some of these embodiments, detecting or predicting occurrence of the failure event can also include sending an indication of the predicted RLF to the wireless network. In some variants, one or more of the following applies:
the indication of the predicted RLF is sent at least a preconfigured duration before a predicted time of the RLF; and
the indication of the predicted RLF includes a predicted time of the RLF.

In some of these embodiments, these exemplary methods can include receiving the ML model from the wireless network. In some variants, the ML model received from the wireless network includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

In other variants, the UE includes a first ML model and the ML model received from the network is a second ML model. In such variants, these exemplary methods can also include selecting the second ML model as the ML model to use for predicting RLF in the first cell, based on one of the following:
the second ML model being received from the network;
receiving an explicit indication from the wireless network to use the second ML model; or
one or more criteria preconfigured in the UE.

In other of these embodiments, these exemplary methods can also include training an initial ML model received from the wireless network to obtain the ML model (i.e., used for predicting RLF). In some variants, the initial ML model received from the wireless network includes a duration that the UE should train the initial ML model.

In some embodiments, the candidate PCell of the selected configuration is one of the following: a currently active SCell, or a configured but currently inactive SCell.

In some embodiments, selecting one of the configurations can be based on one or more of the following:
measurements by the UE in the respective candidate PCells of the plurality of configurations;
respective selection criteria included in the plurality of configurations; and
whether use of the respective configurations require RRC reconfiguration procedures.

In some of these embodiments, these exemplary methods can also include sending an indication of the selected configuration to the wireless network.

In other embodiments, these exemplary methods can also include receiving from the wireless network an indication of one of the configurations selected by the wireless network. In such embodiments, selecting one of the configurations includes selecting the configuration indicated by the wireless network.

Other embodiments include methods (e.g., procedures) for a network node (e.g., base station, eNB, gNB, ng-eNB, etc.) configured to communicate with a UE via a PCell and one or more SCells in a wireless network.

These exemplary methods can include sending, to the UE, a plurality of configurations for a corresponding plurality of candidate PCells. These exemplary methods can also include selecting one of the configurations upon occurrence of a failure event in a first cell configured as the PCell. These exemplary methods can also include switching the PCell from the first cell to the candidate PCell corresponding to the selected configuration.

In some embodiments, switching the PCell from the first cell to the candidate PCell of the selected configuration is performed without an RRC reconfiguration procedure.

In some embodiments, the plurality of configurations are included in a respective plurality of RRCReconfiguration messages or SpCellConfig IEs. Furthermore, the plurality of RRCReconfiguration messages or SpCellConfig IEs are sent to the UE in one or more RRCReconfiguration messages.

In various embodiments, each of the plurality of configurations has one or more of the various characteristics summarized above for UE embodiments.

In some embodiments, the one or more SCells include a second SCell that is configured as an active SCell before the failure event. In such embodiments, the exemplary method can also include, based on switching the PCell to the candidate PCell, switching the active SCell from the second cell to a candidate SCell associated with the candidate PCell.

In some embodiments, the failure event can be one of the following: detected RLF in the first cell; detected radio problems indicating early RLF in the first cell; expiration of a timer indicating early RLF in the first cell; or predicted RLF in the first cell.

In some embodiments, these exemplary methods can also include detecting or predicting occurrence of the failure event. In some of these embodiments, detecting or predicting occurrence of the failure event can include predicting RLF in the first cell based on an ML model and one or more of the following: measurements made by the network node in the first cell; and UE-reported measurements in the first cell. In some of these embodiments, detecting or predicting occurrence of the failure event can also include sending an indication of the predicted RLF to the UE. In some variants, one or more of the following applies:
the indication of the predicted RLF is sent at least a preconfigured duration before a predicted time of the RLF; and
the indication of the predicted RLF includes a predicted time of the RLF.

In other embodiments, these exemplary methods can also include receiving an indication of the failure event from the UE. In some of these embodiments, the failure event indicated by the UE can be predicted by the UE based on an ML model. In some of these embodiments, these exemplary methods can also include sending one of the following to the UE: the ML model (i.e., used by the UE to predict the indicated failure event), or an initial ML model to be trained by the UE to obtain the ML model. For example, this operation can be performed before receiving the indication of the failure event.

In some variants, the ML model sent to the UE includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

In other variants, the UE includes a first ML model and the ML model sent to the UE is a second ML model. In such variants, these exemplary methods can also include indicating that the UE should select the second ML model for predicting RLF in the first cell based on one of the following: the second ML model being sent to the UE, or an explicit indication.

In other variants, the initial ML model sent to the UE includes a duration that the UE should train the initial ML model.

In some embodiments, the candidate PCell of the selected configuration is one of the following: a currently active SCell, or a configured but currently inactive SCell.

In some embodiments, selecting one of the configurations can be based on one or more of the following:
measurements by the network node in the respective candidate PCells of the plurality of configurations;
respective selection criteria included in the plurality of configurations; and
whether use of the respective configurations require RRC reconfiguration procedures.

In some of these embodiments, these exemplary methods can also include sending an indication of the selected configuration to the UE.

In other embodiments, these exemplary methods can also include receiving, from the UE, an indication of one of the configurations selected by the UE. In such embodiments, selecting one of the configurations includes selecting the configuration indicated by the UE.

Other embodiments include UEs (e.g., wireless devices, IoT devices, etc.) and network nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs or network nodes to perform operations corresponding to any of the exemplary methods described herein.

These and other embodiments described herein can avoid connectivity interruption when a UE detects RLF on its PCell and no PSCell is configured (e.g., CA without DC). Embodiments enable the UE to avoid performing an RRC re-establishment procedure that may interrupt connectivity for several seconds, and to avoid an RRC reconfiguration when switching between PCell configurations. In this manner, embodiments can improve network connectivity for various services.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 show high-level views of exemplary 5G network architectures.

FIG. 3 shows exemplary NR user plane (UP) and control plane (CP) protocol stacks.

FIGS. 4-5 are timing diagrams illustrating various aspects of a radio link failure (RLF) experienced by a UE.

FIG. 6 illustrates carrier aggregation (CA)-level packet duplication in NR.

FIG. 7 shows an example of classification-type machine learning (ML).

FIG. 8 shows an exemplary ML classification model for predicting coverage probability on another carrier.

FIG. 9 is a flow diagram illustrating exemplary methods (e.g., procedures) for a UE (e.g., wireless device, IoT device, etc.), according to various embodiments of the present disclosure.

FIG. 10 is a flow diagram illustrating exemplary methods (e.g., procedures) for a network node (e.g., base station, eNB, gNB, ng-eNB, etc.), according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows a high-level view of an exemplary 5G network architecture, including a NG-RAN 299 and a 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to access and mobility management functions (AMF, e.g., 230a,b) via respective NG-C interfaces and to user plane functions (UPFs, e.g., 240a,b) via respective NG-U interfaces. Moreover, the AMFs 230a,b can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth-generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

Each of the gNBs can include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, a gNB can transmit different versions of the same signal to a single UE via multiple TRPs. Each of the TRPs can also employ beams for transmission and reception towards UEs served by the gNB.

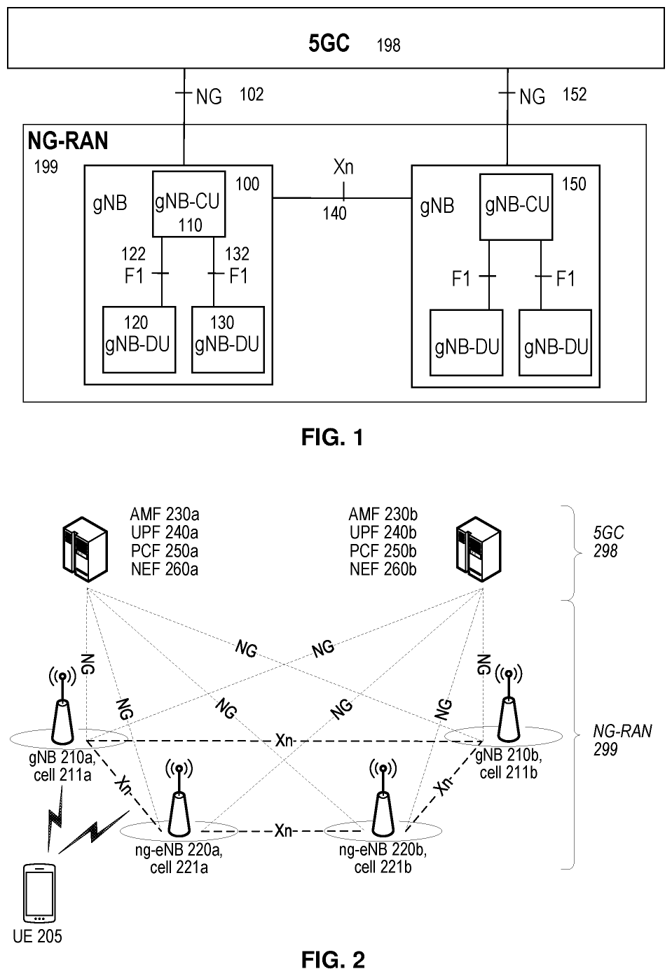

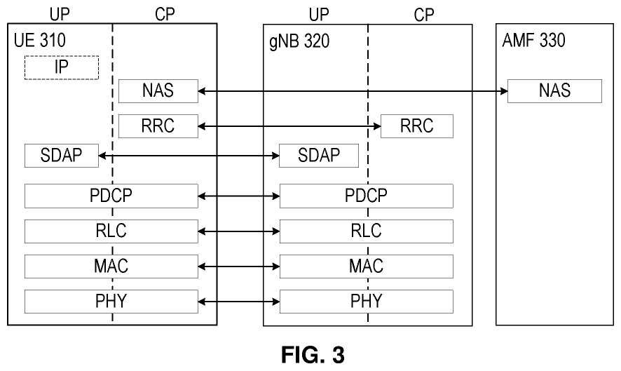

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

As briefly mentioned above, there are various problems, issues, and/or difficulties with RLF for NR UEs operating in non-DC modes such as CA, particularly at high frequencies where the chance to experience RLF due to propagation loss and blockages greatly increases. This is discussed in more detail below.

When CA is configured without DC, the UE only has one RRC connection with the network. The UE's PCell provides the NAS mobility information at RRC connection establishment/re-establishment/handover and provides the security input at RRC connection re-establishment/handover. The configured set of serving cells for a UE in CA always includes one PCell and one or more SCells. When DC is configured, one carrier under the SCG is used as the PSCell, such that the MCG includes one PCell and zero or more SCell(s) while the SCG includes one PSCell and one or more SCell(s). In general, then, the configured set of serving cells for a UE in CA or DC always consists of one PCell and one or more SCells.

Since CA aggregates multiple independent carriers for parallel and simultaneous communications, scheduling and data transmission/reception are done independently by each CC and most conventional (e.g., non-CA) functions can be reused for each CC in LTE CA. In LTE Rel-12 CA, however, the UE can only PUCCH carrying UL control information (UCI) via the PCell. This UCI includes scheduling requests (SR) for UL transmissions, hybrid ARQ (HARQ) feedback for DL data transmissions on PCell and SCells, and Channel State Information (CSI) for all DL CCs.

Restricting PUCCH to PCell avoids mandating more than one uplink CC. Furthermore, restricting PUCCH to PCell allows a UE to use a unified UCI transmission framework regardless of its uplink CA capability. However, if a particular carrier is used as the PCell for many UEs configured with CA, there can be a shortage of UL radio resources due to the increased PUCCH load on that carrier.

A typical example is CA operating on heterogeneous networks where many small cells are deployed in the coverage of a macro cell. The relatively low-powered small cells are deployed in high traffic areas with different frequencies from the macro cell. In areas where these small cells are overlaid on the macro cell, UE can be configured with CA for the small cells and the macro cell.

To address this issue, 3GPP Rel-13 CA enables PUCCH configuration for an SCell (i.e., the PUCCH-SCell) in addition to the PCell. When CA is performed with this function, CCs are grouped with either the PCell or the PUCCH-SCell. The UE sends UCI for CCs via the PCell or the PUCCH-SCell according to the respective groupings. With this arrangement, UL radio resource shortages can be mitigated by offloading UCI from macro cell to small cells while keeping the macro cell as the PCell. In DC, the UE always transmit PUCCH on a PCell or a PSCell.

The reconfiguration, addition, and removal of SCells can be performed by RRC, such as at intra-RAT handover. When adding a new SCell, dedicated RRC signaling is used for sending all required system information (SI) of the SCell. As such, UEs need not acquire broadcast system information directly from the SCells while operating in RRC_CONNECTED mode.

The number of serving cells that can be configured depends on the aggregation capability of the UE. For each SCell the usage of uplink resources by the UE is configurable. For example, the number of configured DL secondary component carriers (SCCs) is always larger than or equal to the number of configured UL SCCs, and no SCell can be configured for UL usage only. From a UE viewpoint, each uplink resource only belongs to one serving cell.

Unlike SCells, PCell cannot be de-activated. Also, a PCell can only be changed with handover procedure including security key change and RACH procedure (unless RACH-less HO is configured). Re-establishment is not triggered when SCells experience RLF, but only when a PCell experiences RLF.

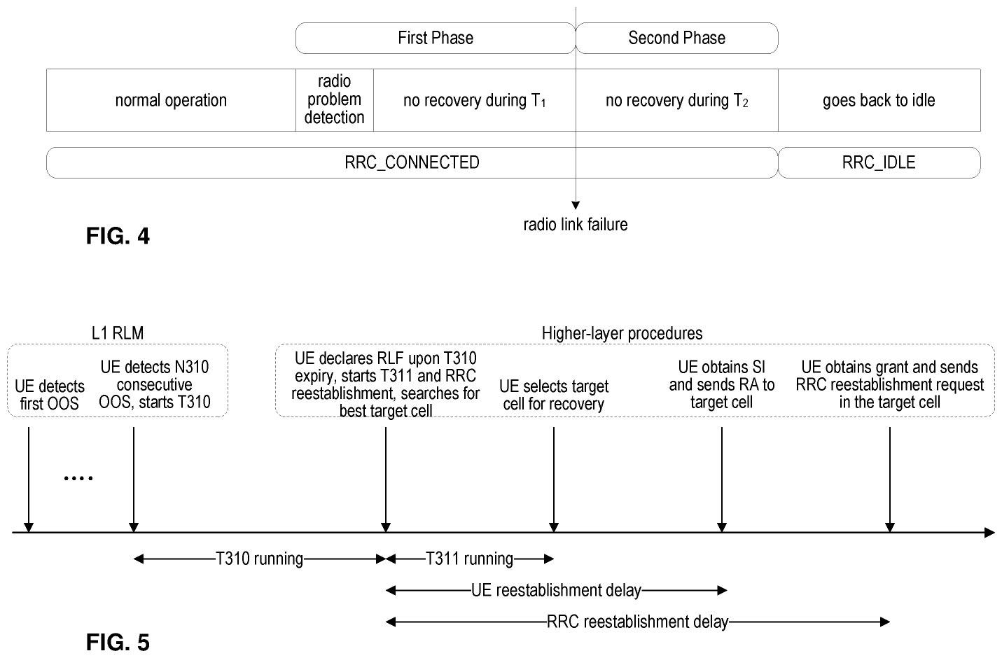

FIG. 4 shows a high-level timing diagram illustrating the two phases of an RLF procedure in LTE and NR. The first phase starts upon radio problem detection on the PCell and leads to RLF detection after no recovery occurs during a period T1. The second phase starts upon RLF detection or handover failure and ends with the UE returning to RRC_IDLE if no recovery occurs during a period T2.

FIG. 5 shows a more detailed version of the UE's operations during an exemplary RLF procedure, such as for LTE or NR. In this example, the UE detects N310 consecutive OOS conditions during L1 RLM procedures on the PCell, as discussed above, and then initiates timer T310. Subsequent operations are performed by higher layers (e.g., RRC). After expiry of T310, the UE starts T311 and RRC reestablishment, searching for the best target cell. After selecting a target cell for reestablishment, the UE acquires system information (SI) for the target cell and performs a random access (RA, e.g., via RACH). The duration after T310 expiry until this point can be considered the UE's reestablishment delay. Ultimately, the UE obtains access to the target cell and sends an RRC Reestablishment Request message to the target cell. The duration after T310 expiry until this point can be considered the total RRC reestablishment delay. If the UE does not successfully reestablish in a target cell before expiration of T311, the UE enters RRC_IDLE and releases its connection to the network.

The timers and counters described above are further described in Tables 1-2 below, respectively. For NR-DC and NGEN-DC, T310 is used for both PCell/MCG and PSCell/SCG. For LTE-DC and NE-DC (i.e., where SN is eNB), T313 is used for PSCell/SCG. The UE reads the timer values from system information (SI) broadcast in the UE's SpCell. Alternatively, the network can configure the UE with UE-specific values of the timers and constants via dedicated RRC signaling (i.e., specific values sent to specific UEs via respective messages).

TABLE 1

| Timer | Start | Stop | At expiry |
|---|---|---|---|
| T310 | Upon detecting physical | Upon receiving N311 consecutive | If the T310 is kept in MCG: |
| | layer problems for | in-sync indications from lower | If AS security is not activated: |
| | the SpCell i.e., upon | layers for the SpCell, upon | go to RRCIDLE else: initiate |
| | receiving N310 consecutive | receiving RRCReconfiguration | the connection re-establishment |
| | out-of-sync indications | with reconfigurationWithSync | procedure. If the T310 is kept in |
| | from lower layers. | for that cell group, and upon | SCG, Inform E-UTRAN/NR about |
| | | initiating the connection | the SCG radio link failure by |
| | | re-establishment procedure. | initiating the SCG failure |
| | | Upon SCG release, if the T310 | information procedure as specified |
| | | is kept in SCG. | in 5.7.3. |
| T311 | Upon initiating the RRC | Upon selection of a suitable | Enter RRC_IDLE |
| | connection re- | NR cell or a cell using | |
| | establishment | another RAT. | |
| | procedure | | |
| T313 | Upon detecting physical | Upon receiving N314 consecutive | Inform E-UTRAN about the SCG |
| | layer problems for the | in-sync indications from lower | radio link failure by initiating |
| | PSCell i.e., upon receiving | layers for the PSCell, upon | the SCG failure information |
| | N313 consecutive | initiating the connection re- | procedure as specified in 5.6.13. |
| | out-of-sync indications | establishment procedure, upon | |
| | from lower layers | SCG release and upon receiving | |
| | | RRCConnectionReconfiguration | |
| | | including | |
| | | MobilityControlInfoSCG | |

TABLE 2

| Constant | Usage |
|---|---|
| N310 | Maximum number of consecutive “out-of-sync” indications |
| | for the SpCell received from lower layers |
| N311 | Maximum number of consecutive “in-sync” indications |
| | for the SpCell received from lower layers |
| N313 | Maximum number of consecutive “out-of-sync” indications |
| | for the PSCell received from lower layers (for LTE SN) |

One reason for introducing the timers and counters listed above is to add some filtering, delay, and/or hysteresis to a UE's determination of failure and/or recovery of a radio link with a serving cell. These parameters avoid a UE abandoning a connection prematurely due to a brief or temporary reduction in link quality that could be recovered by the UE (e.g., before T310 expires, before the counter value N310, etc.). In general, this improves user experience.

According to 3GPP TS 36.331 (v15.7.0), possible causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report; and
4) Reaching a maximum number of RLC retransmissions for a signaling radio bearer (SRB) or for a data radio bearer (DRB).

When RLF is detected, the UE prepares a RLF report that includes, among other information, the measurement status of the serving and neighbor cells when RLF was detected. The UE then goes to RRC_IDLE mode and selects a serving cell based on idle-mode cell selection procedures. The selected cell could be the cell in which the RLF occurred, a different cell served by the same network node, or a cell served by a different network node. The UE starts an RRC reestablishment procedure towards the selected cell, including sending a reestablishment message with a cause value set to rlf-cause.

To enhance reliability, NR includes duplication of packets at either the DC level (i.e., different nodes) or the CA level (i.e., different cells). In case of CA-level duplication, two RLC entities—one for the PCell and another for the SCell—are mapped to the same PDCP entity with logical channel (carrier) restriction ensuring that only one RLC entity is mapped only to the carriers comprising the CA tuple. In other words, original and duplicate packets will not be sent over the same carrier. CA duplication can be enabled for DRBs and for SRBs. In general, if the CA-level duplication is configured for a DRB, then it can be assumed that CA-level duplication is configured for SRBs.

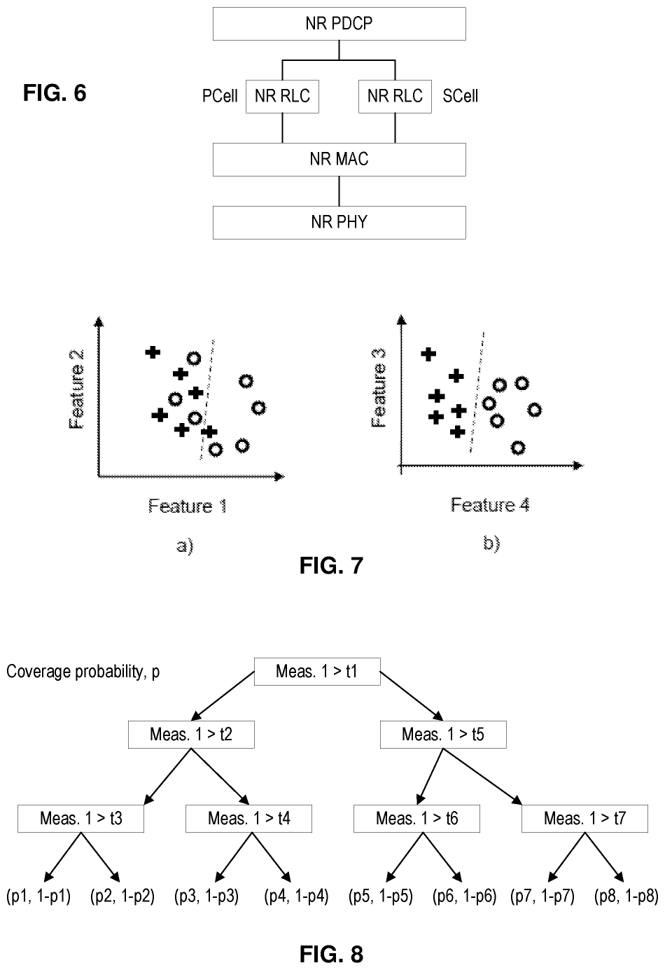

FIG. 6 illustrates CA-level packet duplication in NR. This arrangement differs from LTE, where the PCell and SCell are mapped to one RLC entity and one PDCP entity.

Machine learning (ML) involves the use of computational algorithms that improve automatically through experience and by use of data. ML can be seen as a part or form of artificial intelligence (AI). ML algorithms build a model based on sample (or training) data that is later used to make predictions or decisions on other data. Put differently, ML can be used to find a predictive function for a given dataset, which can be a mapping between input(s) and output(s). The predictive function (or mapping function) is generated in a training phase, where the training phase assumes knowledge of both the input and output. The test phase comprises predicting the output for a given input. Applications of ML include curve fitting, facial recognition, and spam filtering.

One type of ML is referred to as classification. FIG. 7 shows an example of classification ML in which the task is to train a predictive function that separates the two classes, shown as “circle” and “cross”. In the left diagram labeled a), features 1 and 2 provide relatively low separation of the output class, leading to a relatively poor prediction performance. In the right diagram labeled b), features 3 and 4 provide better separation of the output class, leading to a better prediction performance. Since ML performance is related (e.g., proportional) to correlation between the input and the output, one key problem in ML is to identify and/or create appropriate features (e.g., features 3 and 4). Another problem is to collect enough data samples for training.

An exemplary classification problem in a radio network context is prediction of coverage on a frequency different from the serving frequency (i.e., a secondary frequency) based on measurements on the serving frequency. For example, one problem is to predict reference signal received power (RSRP) of a secondary frequency based on RSRP, timing advance (TA), and precoder index of cells on a serving frequency (including neighbor cells). The data could be collected through measurement reports or through specific combinations of UE RRM events (e.g., so-called “A2”, “A5”, etc.) and inter-frequency measurement reports. Once trained on a training dataset, the ML classification model can output an estimate of coverage for different frequencies given new input data. This estimate can be utilized by the UE or the network in different ways, such as filtering relevant frequency candidates for mobility operations.

FIG. 8 shows an exemplary ML classification model for predicting the coverage probability on another carrier. In particular, a network has trained a decision tree for predicting the coverage probability on another carrier given five (5) different measurements on the source carrier. Measurements can include RSRP and/or RSRQ of the serving cell and/or neighboring cell, RSRP/RSRQ beam measurements for NR, etc. The coverage probability is denoted by p, and no coverage is defined as (1−p). Each leaf node in the tree provides a different coverage probability, labelled p1-p8 respectively.

As discussed above in relation to FIG. 5, an RRC re-establishment procedure will be triggered when a UE detects an RLF in the PCell. When the UE is configured for CA but not for MR-DC, this causes a connectivity interruption since the UE has no PSCell to maintain communication. This can be particularly problematic for NR networks deployed at high frequencies (e.g., millimeter wave), where the likelihood of RLF due to propagation loss and blockages increases greatly.

Embodiments of the present disclosure can address these and other issues, problems, and/or difficulties by novel, flexible, and efficient techniques to avoid connectivity interruption when a UE detects RLF on the PCell and no PSCell is configured (e.g., non-DC CA). In particular, when setting up CA, the network may provide the UE with different configurations, each including a new PCell configuration and/or a new SCell configuration. One of these configurations can be selected for use when the UE determines that an RLF has occurred or is likely to occur on the current PCell. In some embodiments, the selection of which configuration to use (i.e., a PCell configuration or an SCell configuration) as a new PCell configuration can be based on a particular trigger condition. In this manner, embodiments enable the UE to avoid performing an RRC re-establishment procedure that may interrupt connectivity for several seconds.

In some embodiments, the determination that an RLF is likely to occur at the UE can be performed using an ML model in the UE or in the network (e.g., serving gNB). When performed at the network, the network can responsively activate one of the configurations previously sent to the UE, thereby enabling the UE to avoid an RRC reestablishment procedure.

Compared to conventional procedures such as conditional handover, embodiments do not require an RRC reconfiguration procedure to be triggered by the UE. This is because all the configurations are already available at the UE, which has already applied them upon receiving the first RRCReconfiguration message. In fact, the UE just needs to switch between configurations, either autonomously or based on a network indication/command. The process of switching has theoretically zero delay at the UE, and practically much smaller delay than conditional handover that requires various RRC messaging between UE and network. As mentioned above, this avoids extended interruptions of connectivity experienced by legacy procedures.

Embodiments are described generally for the scenario where the UE detects RLF on the PCell. However, substantially similar techniques may be applied to the scenario where the UE detects RLF on a PSCell or an SCell. Further, embodiments are described generally for the scenario where the UE is in “standalone” NR (or LTE) operation, but substantially similar techniques may be applied to the scenario where the UE is in DC (i.e., regardless of DC option being used).

In some embodiments, upon detecting a RLF in the PCell, the UE selects one of stored configurations and applies it to switch to another PCell. In other embodiments, when the network detects a RLF for the UE in the PCell, the network sends the UE an indication of which the UE's stored configuration should be used by the UE to switch from the failed PCell to another PCell. In contrast to conventional techniques, no RRC reconfiguration procedure is triggered by the UE, which has previously received and stored all relevant configurations and has already applied them upon receiving the first RRCReconfiguration message. In fact, the UE just needs to switch (autonomously or by a network indication) from one configuration to another.

In some embodiments, the stored configurations may refer to multiple RRCReconfiguration messages. In other embodiments, the stored configurations may refer to multiple SpCellConfig information elements (IEs), e.g., received in the same RRC message or in different RRC messages. In other embodiments, the stored configurations may refer to a multiple of any configuration allowing the UE to switch from the failed PCell to another PCell.

In some embodiments, the stored configurations may refer to a multiple of any configuration allowing the UE to reconfigure an SCell so that an indication about the detected RLF can be sent to the network. In other embodiments, the stored configurations may refer to a multiple of any configuration allowing the UE to reconfigure both the PCell and the SCell. In other embodiments, the stored configurations may refer to a multiple of any configuration allowing the UE to send an indication of the detected (or predicted) RLF to the network and to reconfigure an SCell without requiring an RRC reconfiguration procedure. In other embodiments, the stored configurations may refer to a multiple of any configuration allowing the UE to reconfigure both the PCell and the SCell without requiring an RRC reconfiguration procedure.

In some embodiments, the UE can use a stored configuration of an SCell (i.e., one that is currently inactive) as the new PCell. In other embodiments, the UE can switch a currently active SCell to be the new PCell.

In some embodiments, switching to a stored configuration can be triggered and/or initiated based on one or more of the following actual or predicted events:
PCell RLF is detected (i.e., timer T310 expires);
PCell radio link problems are detected (i.e., timer T310 is started);
Early RLF timer (e.g., T318) expires; and/or
Predicted occurrence of an RLF (e.g., based on ML model).

In some embodiments, when the triggering is based on RLF prediction by the UE, the RLF prediction can be based on an ML model in the UE, or any other type of mathematical and/or statistical model that can be used for predicting occurrence of an event. In some variants, the ML model can be sent from the network to the UE and can be trained by the network, the UE, or a combination. In other embodiments, the ML model to use for RLF prediction can be selected and/or determined by the UE itself. The input to the model can be the same as for conventional RLF monitoring, e.g., in-sync and out-of-sync indications from the physical layer or the number of RLC retransmissions. In some variants, other input such as UE RSRP and/or RSRQ measurements can be used.

In other embodiments, if an ML model is used for the RLF prediction, the UE could be configured (e.g., by the network) or pre-configured (e.g., an internal model) with a time window parameter that indicates how far in advance of a predicted RLF that the UE should trigger the RLF recovery action. For example, the UE can be (pre-)configured to report a predicted RLF or trigger RLF recovery within 10 seconds before the predicted event. In other embodiments, the UE can report the predicted RLF along with an indication of the predicted time of occurrence, which can be absolute or relative to the report of the predicted RLF.

In some embodiments, if the UE has its own ML model and also an ML model received from the network, the UE selects between these ML models based on an explicit indication received from the network. In other embodiments, if the UE has its own ML model and also an ML model received from the network, the reception of the ML model is an implicit indication that the UE should use that one by default. In other embodiments, the UE can select between its own ML model and the ML model received from the network based on its own implementation preferences, based on 3GPP specification, or based on one or more other criteria.

In some embodiments, the selection of stored configuration to use after detection of RLF, detection of early RLF, or RLF prediction can be based on currently available measurement results in the UE regarding serving cell (PCell, SCell) quality and neighboring cell quality. For example, the configuration corresponding to the best (e.g., according to some criteria) measured signal quality can be selected.

In other embodiments, upon detecting an early radio link problem on the PCell and having selected a stored configuration to be used, but before applying the selected configuration, the UE starts to perform measurements on the cell indicated by the selected configuration.

In some embodiments, the measurement configuration related to the newly selected cell can be part of the selected configuration. In other embodiments, the measurement configuration related to the newly selected cell can be previously configured by the network, i.e., separate from the selected configuration.

In other embodiments, when performing measurements on the newly selected cell, the UE stops the measurement on the cell in which RLF was detected or predicted. In some embodiments, the UE can use a configured measurement gap (if configured) when performing the measurements on the selected cell.

In some embodiments, upon detecting or predicting RLF or detecting early RLF on the PCell and selecting a stored configuration to be used for the PCell change, the UE applies the selected configuration only when certain measurements performed on the candidate PCell are above a threshold. For example, the threshold can correspond to some degree of certainty that the candidate PCell is able to provide connectivity for the UE. Such measurements can include RSRP, RSRQ, SINR, etc.

In some embodiments, the network can send the UE multiple configurations in the same RRC message, from which the UE can select one to be used upon detecting or predicting RLF or detecting early RLF on the PCell. In some embodiments, the multiple configurations can include respective criteria (e.g., triggering conditions) for when the respective configurations should be selected/used.

In some embodiments, upon detecting radio link problems on the PCell (i.e., early RLF), the network sends an indication of which stored configuration should be used by the UE. In other embodiments, the network predicts a likely RLF (e.g., according to some probability or likelihood of occurrence) on the PCell according to its own ML model and sends the UE an indication of this predicted RLF. Yet, in other embodiments, the network predicts a likely RLF on the PCell according to its own ML model and sends an indication of which stored configuration should be used by the UE, either immediately or at a predicted time of occurrence of the (predicted) RLF.

In various embodiments, the indication of which stored configuration to be used can sent via dedicated RRC message, MAC control element (CE), or layer-1 DL control information (DCI).

In some embodiments, the network sends the UE an ML model to use for RLF prediction. Upon predicting an RLF based on the ML model, the UE can apply one of the configurations received. For example, the ML model can be sent with the configurations. When sending this ML model, the network can include one or more of the following:
Prediction accuracy for the ML model;
If no prediction accuracy provided, whether the UE should report accuracy of its RLF predictions based on the ML model;
Duration of applicability for the ML model;
Duration that the UE should train the ML model;
How far in advance the UE should report a predicted RLF, e.g., 5 seconds before its predicted occurrence; and
Whether the UE should report a predicted duration of the RLF.

In other embodiments, the network may send an explicit indication to the UE that the ML model provided by the network should be used for RLF prediction. Alternatively, the network may send an explicit indication to the UE that the UE may use its own ML model (if available) for RLF prediction. In another alternative, the network may indicate to the UE that it supports RLF prediction by ML model(s). This indication can be broadcast in a cell (e.g., in an SI block or SIB) or sent via dedicated RRC signaling to specific UEs.

In general, the UE and the network perform complementary operations with respect to switching PCells used by the UE. This is because both UE and network must have the same understanding about which network-provided cell is UE's PCell, since a PCell has unique characteristics relative to SCells (e.g., cannot be deactivated).

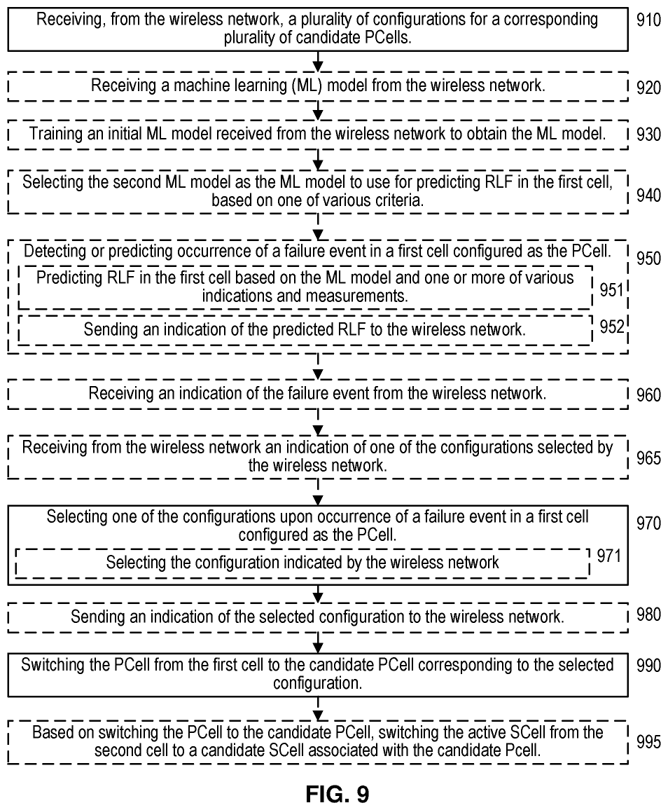

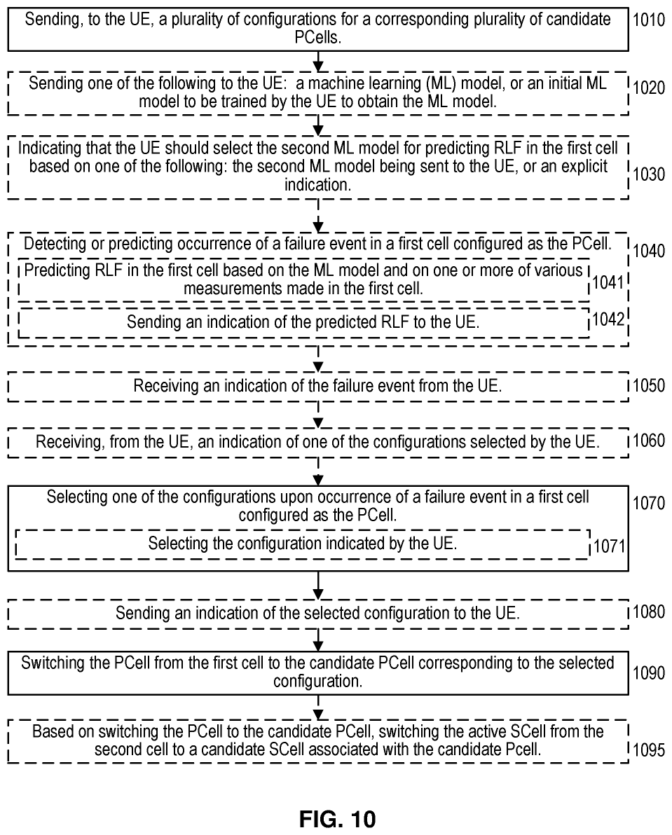

The embodiments described above can be further illustrated by FIGS. 9-10, which depict exemplary methods (e.g., procedures) for a UE and a network node, respectively. In other words, various features of the operations described below with reference to FIGS. 9-10 correspond to various embodiments described above. The exemplary methods shown in FIGS. 9-10 can be used cooperatively to provide various exemplary benefits described herein. Although FIGS. 9-10 show specific blocks in particular orders, the operations of the blocks can be performed in different orders than shown and can be combined and/or divided into blocks having different functionality than shown. Optional blocks or operations are indicated by dashed lines.

In particular, FIG. 9 is a flow diagram illustrating an exemplary method (e.g., procedure) for a UE configured to communicate with a wireless network via a primary cell (PCell) and one or more secondary cells (SCells), according to various embodiments of the present disclosure. The exemplary method shown in FIG. 19 can be implemented by a UE (e.g., wireless device, IoT device, etc. or component thereof) such as described elsewhere herein.

The exemplary method can include the operations of block 910, in which the UE can receive, from the wireless network, a plurality of configurations for a corresponding plurality of candidate PCells (i.e., one-to-one correspondence between configurations and candidate PCells). The exemplary method can also include the operations of block 970, in which the UE can select one of the configurations upon occurrence of a failure event in a first cell configured as the PCell. The exemplary method can also include the operations of block 990, in which the UE can switch the PCell from the first cell to the candidate PCell corresponding to the selected configuration.

In some embodiments, switching the PCell from the first cell to the candidate PCell of the selected configuration is performed in block 990 without an RRC reconfiguration procedure.

In some embodiments, the plurality of configurations are included in a respective plurality of RRCReconfiguration messages or SpCellConfig IEs. Furthermore, the plurality of RRCReconfiguration messages or SpCellConfig IEs are received (e.g., in block 910) in one or more RRCReconfiguration messages.

In various embodiments, each of the plurality of configurations has one or more of the following characteristics:
corresponds to a candidate PCell that is different than the first cell;
includes one or more candidate SCells that are different than currently active SCells;
facilitates sending an indication about a PCell failure event to the wireless network;
facilitates switching PCell without performing an RRC reconfiguration procedure; and
facilitates switching at least one currently active SCell without performing an RRC reconfiguration procedure.

In some embodiments, the one or more SCells include a second SCell that is configured as an active SCell before the failure event. In such embodiments, the exemplary method can also include the operations of block 995, where based on switching the PCell to the candidate PCell, the UE can switch the active SCell from the second cell to a candidate SCell associated with the candidate PCell.

In some embodiments, the failure event can be one of the following: detected RLF in the first cell; detected radio problems indicating early RLF in the first cell; expiration of a timer indicating early RLF in the first cell; or predicted RLF in the first cell.

In some embodiments, the exemplary method can also include the operations of block 960, where the UE can receive an indication of the failure event from the wireless network. In other embodiments, the exemplary method can also include the operations of block 950, where the UE can detect or predict occurrence of the failure event.

In some of these embodiments, detecting or predicting occurrence of the failure event in block 950 can include the operations of sub-block 951, where the UE can predict RLF in the first cell based on an ML model and on one or more of the following: in-sync and out-of-sync indications from the UE's physical layer; and measurements made by the UE in the first cell. In some of these embodiments, detecting or predicting occurrence of the failure event in block 950 can also include the operations of sub-block 952, where the UE can send an indication of the predicted RLF to the wireless network. In some variants, one or more of the following applies:
the indication of the predicted RLF is sent at least a preconfigured duration before a predicted time of the RLF; and
the indication of the predicted RLF includes a predicted time of the RLF.

In some of these embodiments (i.e., that include sub-block 951), the exemplary method can include the operations of block 920, where the UE can receive the ML model from the wireless network. In some variants, the ML model received from the wireless network includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

In other variants, the UE includes a first ML model and the ML model received from the network is a second ML model. In such variants, the exemplary method can also include the operations of block 940, where the UE can select the second ML model as the ML model to use for predicting RLF in the first cell, based on one of the following:
the second ML model being received from the network;
receiving an explicit indication from the wireless network to use the second ML model; or
one or more criteria preconfigured in the UE.

In other of these embodiments, the exemplary method can include the operations of block 930, where the UE can train an initial ML model received from the wireless network to obtain the ML model (i.e., used for predicting RLF). In some variants, the initial ML model received from the wireless network includes a duration that the UE should train the initial ML model.

In some embodiments, the candidate PCell of the selected configuration is one of the following: a currently active SCell, or a configured but currently inactive SCell.

In some embodiments, selecting one of the configurations in block 980 is based on one or more of the following:
measurements by the UE in the respective candidate PCells of the plurality of configurations;
respective selection criteria included in the plurality of configurations; and
whether use of the respective configurations require RRC reconfiguration procedures.

In some of these embodiments, the exemplary method also includes the operations of block 980, where the UE can send an indication of the selected configuration to the wireless network. In other embodiments, the exemplary method can also include the operations of block 965, where the UE can receive from the wireless network an indication of one of the configurations selected by the wireless network. In such embodiments, selecting one of the configurations in block 970 includes the operations of sub-block 971, where the UE can select the configuration indicated by the wireless network.

In addition, FIG. 10 is a flow diagram illustrating an exemplary method (e.g., procedure) for a network node configured to communicate with a UE via a PCell and one or more SCells in a wireless network, according to various embodiments of the present disclosure. The exemplary method shown in FIG. 10 can be implemented by a network node (e.g., base station, eNB, gNB, ng-eNB, etc.) such as described elsewhere herein.

The exemplary method can include the operations of block 1010, in which the network node can send, to the UE, a plurality of configurations for a corresponding plurality of candidate PCells (i.e., one-to-one correspondence between configurations and candidate PCells). The exemplary method can include the operations of block 1070, in which the network node can select one of the configurations upon occurrence of a failure event in a first cell configured as the PCell. The exemplary method can also include the operations of block 1090, in which the network node can switch the PCell from the first cell to the candidate PCell corresponding to the selected configuration.

In some embodiments, switching the PCell from the first cell to the candidate PCell of the selected configuration is performed in block 1090 without an RRC reconfiguration procedure.

In some embodiments, the plurality of configurations are included in a respective plurality of RRCReconfiguration messages or SpCellConfig IEs. Furthermore, the plurality of RRCReconfiguration messages or SpCellConfig IEs are sent (e.g., in block 1010) in one or more RRCReconfiguration messages.

In various embodiments, each of the plurality of configurations has one or more of the following characteristics:
corresponds to a candidate PCell that is different than the first cell;
includes one or more candidate SCells that are different than currently active SCells;
facilitates sending an indication about a PCell failure event to the wireless network;
facilitates switching PCell without performing an RRC reconfiguration procedure; and
facilitates switching at least one currently active SCell without performing an RRC reconfiguration procedure.

In some embodiments, the one or more SCells include a second SCell that is configured as an active SCell before the failure event. In such embodiments, the exemplary method can also include the operations of block 1095, where based on switching the PCell to the candidate PCell, the network node can switch the active SCell from the second cell to a candidate SCell associated with the candidate PCell.

In some embodiments, the failure event can be one of the following: detected RLF in the first cell; detected radio problems indicating early RLF in the first cell; expiration of a timer indicating early RLF in the first cell; or predicted RLF in the first cell.

In some embodiments, the exemplary method can also include the operations of block 1040, where the network node can detect or predict occurrence of the failure event.

In some of these embodiments, detecting or predicting occurrence of the failure event in block 1040 can include the operations of sub-block 1041, where the network node can predict RLF in the first cell based on an ML model and on one or more of the following: measurements made by the network node in the first cell; and UE-reported measurements in the first cell. In some of these embodiments, detecting or predicting occurrence of the failure event in block 1040 can include the operations of sub-block 1042, where the network node can send an indication of the predicted RLF to the UE. In some variants, one or more of the following applies:
the indication of the predicted RLF is sent at least a preconfigured duration before a predicted time of the RLF; and
the indication of the predicted RLF includes a predicted time of the RLF.

In other embodiments, the exemplary method can also include the operations of block 1050, where the network node can receive an indication of the failure event from the UE. In some of these embodiments, the failure event indicated by the UE can be predicted by the UE based on an ML model. In some of these embodiments, the exemplary method can include the operations of block 1020, where the network node can send one of the following to the UE: the ML model (i.e., used by the UE to predict the indicated failure event), or an initial ML model to be trained by the ULE to obtain the ML model. For example, this operation can be performed before receiving the indication of the failure event in block 1050.

In some variants, the ML model sent to the UE includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

In other variants, the UE includes a first ML model and the ML model sent to the UE is a second ML model. In such variants, the exemplary method can also include the operations of block 1030, where the network node can indicate that the UE should select the second ML model for predicting RLF in the first cell based on one of the following: the second ML model being sent to the UE, or an explicit indication.

In other variants, the initial ML model sent to the UE includes a duration that the UE should train the initial ML model.

In some embodiments, the candidate PCell of the selected configuration is one of the following: a currently active SCell, or a configured but currently inactive SCell.

In some embodiments, selecting one of the configurations in block 1070 is based on one or more of the following:
measurements by the network node in the respective candidate PCells of the plurality of configurations;
respective selection criteria included in the plurality of configurations; and
whether use of the respective configurations require RRC reconfiguration procedures.

In some of these embodiments, the exemplary method also includes the operations of block 1080, where the network node can send an indication of the selected configuration to the UE.

In other embodiments, the exemplary method can also include the operations of block 1060, where the network node can receive, from the UE, an indication of one of the configurations selected by the UE. In such embodiments, selecting one of the configurations in block 1070 includes the operations of sub-block 1071, where the network node can select the configuration indicated by the UE.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

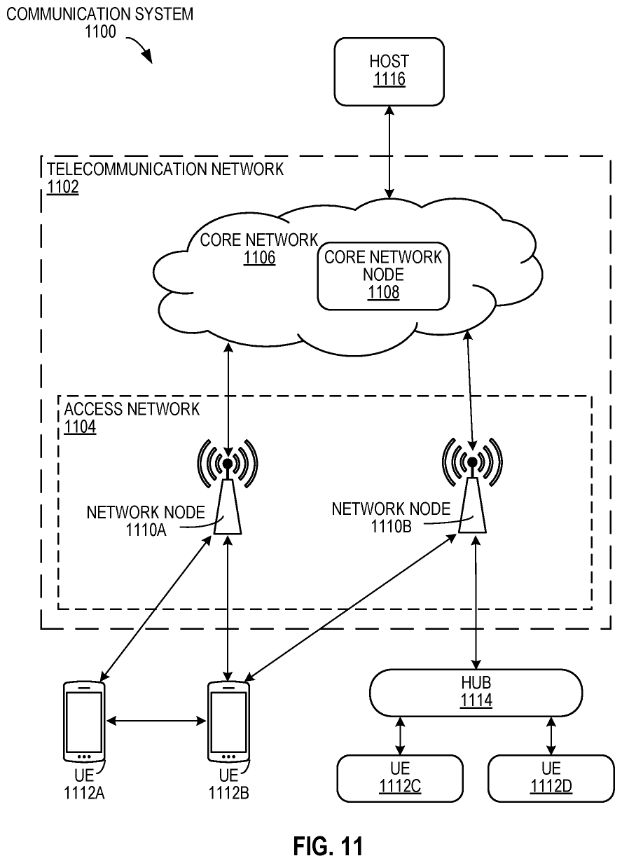

FIG. 11 shows an example of a communication system 1100 in accordance with some embodiments. In this example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

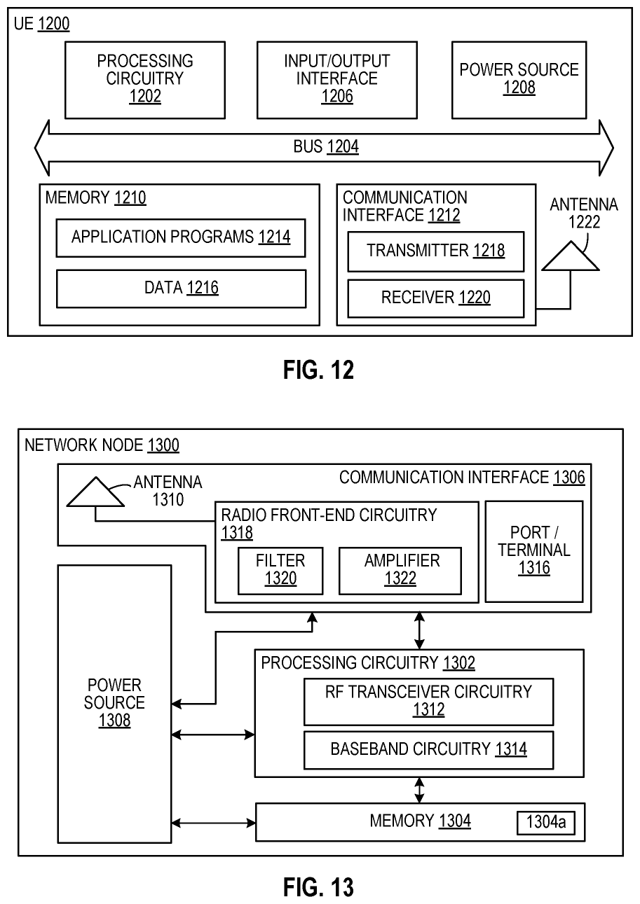

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

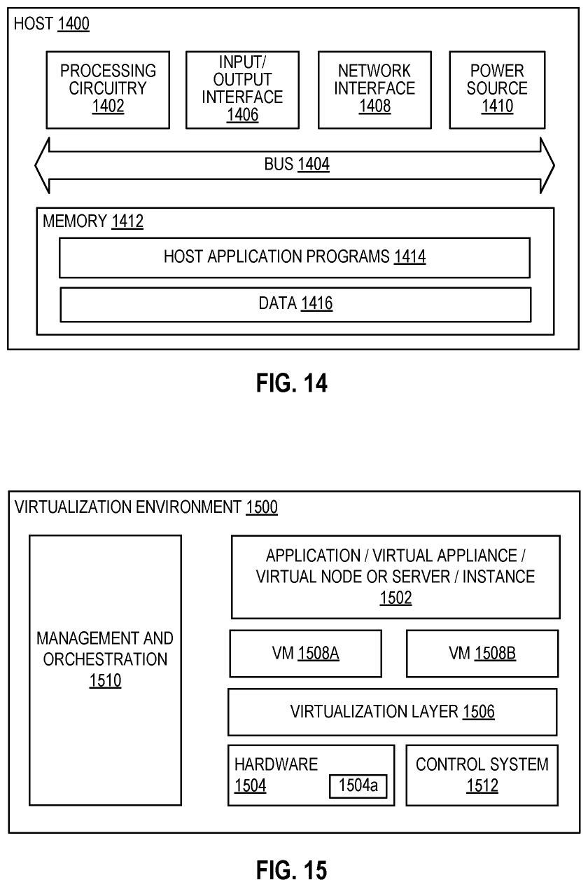

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506.

Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine.

Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

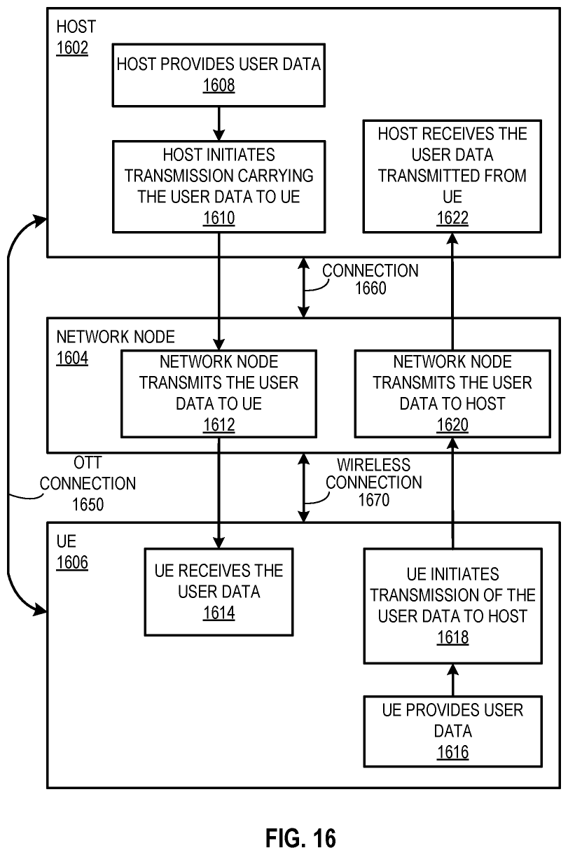

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, these embodiments provide novel, flexible, and efficient techniques to avoid connectivity interruption when a UE detects RLF on the PCell and no PSCell is configured (e.g., no DC). More specifically, embodiments enable the UE to avoid performing an RRC re-establishment procedure that may interrupt connectivity for several seconds. In this manner, embodiments can improve network connectivity for OTT services, thereby increasing the value of such services to end users and service providers.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above or by supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously.

Further, to the extent that the prior art knowledge has not been explicitly incorporated by reference herein above, it is explicitly incorporated herein in its entirety. All publications referenced are incorporated herein by reference in their entireties.

Embodiments of the present disclosure include, but are not limited to, the following enumerated examples.
A1. A method for a user equipment (UE) configured to operate in a wireless network using a primary cell (PCell) and one or more secondary cells (SCells), the method comprising:
   receiving, from the wireless network, a plurality of configurations for a respective plurality of candidate PCells;
   selecting one of the configurations upon occurrence of a failure event in a first cell configured as the PCell; and
   switching the PCell from the first cell to the candidate PCell of the selected configuration.
A2. The method of embodiment A1, wherein the failure event is one of the following:
   detected radio link failure (RLF) in the first cell;
   detected radio problems indicating early RLF in the first cell;
   expiration of a timer indicating early RLF in the first cell; or predicted RLF in the first cell.
A3. The method of any of embodiments A1-A2, further comprising one of the following:
   detecting or predicting occurrence of the failure event; or
   receiving an indication of the failure event from the wireless network.
A4. The method of embodiment A3, wherein detecting or predicting occurrence of the failure event comprises predicting radio link failure (RLF) in the first cell based on a machine learning (ML) model and one or more of the following:
   in-sync and out-of-sync indications from the UE's physical layer; and
   measurements made by the UE in the first cell.
A4a. The method of embodiment A4, wherein detecting or predicting occurrence of the failure event further comprises sending an indication of the predicted RLF to the wireless network.
A4b. The method of embodiment A4a, wherein one or more of the following applies:
   the indication of the predicted RLF is sent at least a preconfigured duration before a predicted time of the RLF; and
   the indication of the predicted RLF includes a predicted time of the RLF.
A5. The method of any of embodiments A4-A4b, further comprising one of the following:
   receiving the ML model from the wireless network; or
   training an initial ML model received from the wireless network to obtain the ML model.
A6. The method of embodiment A5, wherein:
   the UE includes a first ML model;
   the ML model received from the network is a second ML model; and
   the method further comprises selecting the second ML model as the ML model to use for predicting RLF in the first cell, based on one of the following:
      the second ML model being received from the network;
      receiving an explicit indication from the wireless network to use the second ML model; or
      one or more criteria preconfigured in the UE.
A7. The method of embodiment A5, wherein the ML model received from the wireless network includes one or more of the following:
   a prediction accuracy for the ML model;
   an indication of whether the UE should report accuracy of RLF predictions based on the ML model;
   duration of applicability for the ML model;
   how far in advance the UE should report an RLF predicted based on the ML model; and
   whether the UE should report an RLF duration predicted based on the ML model.
A8. The method of embodiment A5, wherein the initial ML model received from the wireless network includes a duration that the UE should train the initial ML model.
A9. The method of any of embodiments A1-A8, wherein the candidate PCell of the selected configuration is one of the following: a currently active SCell, or a configured but currently inactive SCell.
A10. The method of any of embodiments A1-A9, wherein selecting one of the configurations is based on one or more of the following:
   measurements by the UE in the respective candidate PCells of the plurality of configurations;
   respective selection criteria included in the plurality of configurations; and
   whether use of the respective configurations require radio resource control (RRC) reconfiguration procedures.
A11. The method of embodiment A10, further comprising sending an indication of the selected configuration to the wireless network.
A12. The method of any of embodiments A1-A9, wherein selecting one of the configurations is responsive to receiving, from the wireless network, an indication of one of the configurations selected by the wireless network.
A13. The method of any of embodiments A1-A12, wherein switching the PCell from the first cell to the candidate PCell of the selected configuration is performed without a radio resource control (RRC) reconfiguration procedure.
B1. A method for a network node configured to serve a user equipment (UE) using a primary cell (PCell) and one or more secondary cells (SCells) in a wireless network, the method comprising:
   sending, to the UE, a plurality of configurations for a respective plurality of candidate primary cells (PCells);
   selecting one of the configurations upon occurrence of a failure event in a first cell configured as the PCell; and
   switching the PCell from the first cell to the candidate PCell of the selected configuration.
B2. The method of embodiment B1, wherein the failure event is one of the following:
   detected radio link failure (RLF) in the first cell;
   detected radio problems indicating early RLF in the first cell;
   expiration of a timer indicating early RLF in the first cell; or
   predicted RLF in the first cell.
B3. The method of any of embodiments B1-B2, further comprising one of the following:
   detecting or predicting occurrence of the failure event; or
   receiving an indication of the failure event from the UE.
B4. The method of embodiment B3, wherein detecting or predicting occurrence of the failure event comprises predicting radio link failure (RLF) in the first cell based on a machine learning (ML) model and one or more of the following:
   measurements made by the network node in the first cell; and
   UE-reported measurements in the first cell.
B4a. The method of embodiment B4, wherein detecting or predicting occurrence of the failure event further comprises sending an indication of the predicted RLF to the UE.
B4b. The method of embodiment B4a, wherein one or more of the following applies:
   the indication of the predicted RLF is sent at least a preconfigured duration before a predicted time of the RLF; and
   the indication of the predicted RLF includes a predicted time of the RLF.
B5. The method of embodiment B3, wherein the indicated failure event is predicted by the UE based on a machine learning (ML) model.
B5a. The method of embodiment B5, further comprising, before receiving the indication of the failure event, sending one of the following to the UE: the ML model, or an initial ML model to be trained by the UE to obtain the ML model.
B6. The method of embodiment B5a, wherein:
   the UE includes a first ML model;
   the ML model sent to the UE is a second ML model; and
   the method further comprises indicating that the UE should select the second ML model for predicting RLF in the first cell based on one of the following: the second ML model being sent to the UE, or an explicit indication.
B7. The method of embodiment B5a, wherein the ML model sent to the UE includes one or more of the following:
   a prediction accuracy for the ML model;
   an indication of whether the UE should report accuracy of RLF predictions based on the ML model;
   duration of applicability for the ML model;
   how far in advance the UE should report an RLF predicted based on the ML model; and
   whether the UE should report an RLF duration predicted based on the ML model.
B8. The method of embodiment B5a, wherein the initial ML model sent to the UE includes a duration that the UE should train the initial ML model.
B9. The method of any of embodiments B1-B8, wherein the candidate PCell of the selected configuration is one of the following: a currently active SCell, or a configured but currently inactive SCell.
B10. The method of any of embodiments B1-B9, wherein selecting one of the configurations is based on one or more of the following:
   measurements by the network node in the respective candidate PCells of the plurality of configurations;
   respective selection criteria included in the plurality of configurations; and
   whether use of the respective configurations require radio resource control (RRC) reconfiguration procedures.
B11. The method of embodiment B10, further comprising sending an indication of the selected configuration to the UE.
B12. The method of any of embodiments B1-B9, wherein selecting one of the configurations is responsive to receiving, from the UE, an indication of one of the configurations selected by the UE.
B13. The method of any of embodiments B1-B12, wherein switching the PCell from the first cell to the candidate PCell of the selected configuration is performed without a radio resource control (RRC) reconfiguration procedure.
C1. A user equipment (UE) configured to operate in a wireless network using a primary cell (PCell) and one or more secondary cells (SCells), the UE comprising:
   communication interface circuitry configured to communicate with a wireless network via the PCell and the one or more SCells; and
   processing circuitry operably coupled to the communication interface circuitry, whereby the communication interface circuitry and processing circuitry are configured to perform operations corresponding to any of the methods of embodiments A1-A13.
C2. A user equipment (UE) configured to operate in a wireless network using a primary cell (PCell) and one or more secondary cells (SCells), the UE being further configured to perform operations corresponding to any of the methods of embodiments A1-A13.
C3. A non-transitory, computer-readable medium storing computer-executable instructions that, when executed by processing circuitry of a user equipment (UE) configured to operate in a wireless network using a primary cell (PCell) and one or more secondary cells (SCells), configure the UE to perform operations corresponding to any of the methods of embodiments A1-A13.
C4. A computer program product comprising computer-executable instructions that, when executed by processing circuitry of a user equipment (UE) configured to operate in a wireless network using a primary cell (PCell) and one or more secondary cells (SCells), configure the UE to perform operations corresponding to any of the methods of embodiments A1-A13.
D1. A network node configured to serve a user equipment (UE) using a primary cell (PCell) and one or more secondary cells (SCells) in a wireless network, the network node comprising:
   communication interface circuitry configured to communicate with the UE via the PCell and the one or more SCells; and
   processing circuitry operably coupled to the communication interface circuitry, whereby the communication interface circuitry and the processing circuitry are configured to perform operations corresponding to any of the methods of embodiments B1-B13.
D2. A network node configured to serve a user equipment (UE) using a primary cell (PCell) and one or more secondary cells (SCells) in a wireless network, the network node being further configured to perform operations corresponding to any of the methods of embodiments B1-B13.
D3. A non-transitory, computer-readable medium storing computer-executable instructions that, when executed by processing circuitry of a network node configured to serve a user equipment (UE) using a primary cell (PCell) and one or more secondary cells (SCells) in a wireless network, configure the network node to perform operations corresponding to any of the methods of embodiments B1-B13.
D4. A computer program product comprising computer-executable instructions that, when executed by processing circuitry of a network node configured to serve a user equipment (UE) using a primary cell (PCell) and one or more secondary cells (SCells) in a wireless network, configure the network node to perform operations corresponding to any of the methods of embodiments B1-B13.

1.-49. (canceled)

50. A method for a user equipment (UE) configured to communicate with a wireless network via a primary cell (PCell) and one or more secondary cells (SCells), the method comprising:
receiving, from the wireless network, a plurality of configurations for a corresponding plurality of candidate PCells;
selecting one of the configurations upon occurrence of a failure event in a first cell configured as the PCell; and
switching the PCell from the first cell to the candidate PCell corresponding to the selected configuration.

51. The method of claim 50, wherein:
the one or more SCells include a second cell that is configured as an active SCell before the failure event; and
the method further comprises, based on switching the PCell to the candidate PCell, switching the active SCell from the second cell to a candidate SCell associated with the candidate PCell.

52. The method of claim 50, wherein each of the plurality of configurations has one or more of the following characteristics:
corresponds to a candidate PCell that is different than the first cell;
includes one or more candidate SCells that are different than currently active SCells;
facilitates sending an indication about a PCell failure event to the wireless network;
facilitates switching PCell without performing a radio resource control (RRC) reconfiguration procedure; and
facilitates switching at least one currently active SCell without performing an RRC reconfiguration procedure.

53. The method of claim 50, wherein the failure event is radio link failure (RLF) and the method further comprises predicting the RLF in the first cell based on a machine learning (ML) model and on one or more of the following:
in-sync and out-of-sync indications from the UE's physical layer; and
measurements made by the UE in the first cell.

54. The method of claim 53, further comprises sending an indication of the predicted RLF to the wireless network, wherein one or more of the following applies:
the indication of the predicted RLF is sent at least a preconfigured duration before a predicted time of the RLF; and
the indication of the predicted RLF includes a predicted time of the RLF.

55. The method of claim 53, further comprising receiving the ML model from the wireless network, wherein the received ML model includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

56. The method of claim 53, further comprising training an initial ML model received from the wireless network to obtain the ML model used for predicting the RLF, wherein the initial ML model indicates a duration that the UE should train the initial ML model.

57. The method of claim 50, wherein one or more of the following applies:
the candidate PCell of the selected configuration is a currently active SCell or a configured but currently inactive SCell; and
switching the PCell from the first cell to the candidate PCell of the selected configuration is performed without a radio resource control (RRC) reconfiguration procedure.

58. The method of claim 50, wherein selecting one of the configurations is based on one or more of the following:
measurements by the UE in the respective candidate PCells of the plurality of configurations;
respective selection criteria included in the plurality of configurations; and
whether use of the respective configurations require radio resource control (RRC) reconfiguration procedures.

59. A method for a network node configured to communicate with a user equipment (UE) via a primary cell (PCell) and one or more secondary cells (SCells) in a wireless network, the method comprising:
sending, to the UE, a plurality of configurations for a corresponding plurality of candidate PCells;
selecting one of the configurations upon occurrence of a failure event in a first cell configured as the PCell; and
switching the PCell from the first cell to the candidate PCell corresponding to the selected configuration.

60. The method of claim 59, wherein:
the one or more SCells include a second cell that is configured as an active SCell; and
the method further comprises, based on switching the PCell to the candidate PCell, switching the active SCell from the second cell to a candidate SCell associated with the candidate PCell.

61. The method of claim 59, wherein each of the plurality of configurations has one or more of the following characteristics:
corresponds to a candidate PCell that is different than the first cell;
includes one or more candidate SCells that are different than currently active SCells;
facilitates sending an indication about a PCell failure event to the wireless network;
facilitates switching PCell without performing a radio resource control (RRC) reconfiguration procedure; and
facilitates switching at least one currently active SCell without performing an RRC reconfiguration procedure.

62. The method of claim 59, wherein the failure event is radio link failure (RLF) and the method further comprises predicting the RLF in the first cell based on a machine learning (ML) model and on one or more of the following:
measurements made by the network node in the first cell; and
reported measurements made by the UE in the first cell.

63. The method of claim 62, further comprising sending an indication of the predicted RLF to the UE, wherein one or more of the following applies:
the indication of the predicted RLF is sent at least a preconfigured duration before a predicted time of the RLF; and
the indication of the predicted RLF includes a predicted time of the RLF.

64. The method of claim 59, wherein the failure event is radio link failure (RLF) and the method further comprises receiving from the UE an indication of the RLF predicted by the UE based on a machine learning (ML) model.

65. The method of claim 64, further comprising sending to the UE the ML model used by the UE to predict the RLF in the first cell, wherein the ML model sent to the UE includes one or more of the following:
a prediction accuracy for the ML model;
an indication of whether the UE should report accuracy of RLF predictions based on the ML model;
duration of applicability for the ML model;
how far in advance the UE should report an RLF predicted based on the ML model; and
whether the UE should report an RLF duration predicted based on the ML model.

66. The method of claim 64, further comprising sending to the UE an initial ML model to be trained by the UE to obtain the ML model used by the UE to predict the RLF, wherein the initial ML model sent to the UE includes a duration that the UE should train the initial ML model.

67. The method of claim 59, wherein one or more of the following applies:
the candidate PCell of the selected configuration is a currently active SCell or a configured but currently inactive SCell; and
switching the PCell from the first cell to the candidate PCell of the selected configuration is performed without a radio resource control (RRC) reconfiguration procedure.

68. The method of claim 59, wherein selecting one of the configurations is based on one or more of the following:
measurements by the network node in the respective candidate PCells of the plurality of configurations;
respective selection criteria included in the plurality of configurations; and
whether use of the respective configurations require radio resource control (RRC) reconfiguration procedures.

69. A user equipment (UE) configured to communicate with a wireless network via a primary cell (PCell) and one or more secondary cells (SCells), the UE comprising:
communication interface circuitry configured to communicate with the wireless network via the PCell and the one or more SCells; and
processing circuitry operably coupled to the communication interface circuitry, whereby the communication interface circuitry and processing circuitry are configured to:
receive, from the wireless network, a plurality of configurations for a corresponding plurality of candidate PCells;
select one of the configurations upon occurrence of a failure event in a first cell configured as the PCell; and
switch the PCell from the first cell to the candidate PCell corresponding to the selected configuration.

70. A network node configured to communicate with a user equipment, UE via a primary cell (PCell) and one or more secondary cells (SCells) in a wireless network, the network node comprising:
communication interface circuitry configured to communicate with the UE via the PCell and the one or more SCells; and
processing circuitry operably coupled to the communication interface circuitry, whereby the communication interface circuitry and the processing circuitry are configured to perform the method of claim 59.
